(19) United States
(12) Patent Application Publication
(10) Pub. No.: US 2026/0075262 A1
(43) Pub. Date: Mar. 12, 2026

(54) METHOD AND APPARATUS FOR EFFECTS RENDERING AND ELECTRONIC DEVICE

(71) Applicant: Beijing Zitiao Network Technology Co., Ltd., Beijing (CN)

(72) Inventors: Fukun XU, Beijing (CN); Yanhao Shen, Beijing (CN); Lixiang Xie, Beijing (CN); Yuanyuan Wang, Beijing (CN)

(21) Appl. No.: 19/315,362

(22) Filed: Aug. 29, 2025

(30) Foreign Application Priority Data
Sep. 11, 2024 (CN) 202411273462.0

(51) Int. Cl. H04N 21/2187; H04N 21/431

(52) U.S. Cl. CPC H04N 21/2187; H04N 21/4312

(57) ABSTRACT

Embodiments of the present disclosure provide a method and apparatus for effects rendering and an electronic device. The method comprises: displaying a live streaming interface, in which a first live streaming frame is displayed; wherein the first live streaming frame is obtained by applying a first effect to a first video source image, the first effect including one or more first effect rendering nodes; in response to receiving a request associated with a second effect, determining a target effect rendering node shared by the first and second effects; obtaining a first frame after processing the first video source image with the target effect rendering node; rendering the first frame with a second effect rendering node of the second effect to obtain a second live streaming frame; displaying the first live streaming frame corresponding to the first video source image and displaying the second live streaming frame in a window.

### CROSS-REFERENCE TO RELATED APPLICATION(S)

This application claims priority to Chinese Application No. 202411273462.0 filed on Sep. 11, 2024, the disclosure of which is incorporated herein by reference in its entirety.

### FIELD Embodiments of the present disclosure relate to the field of computer technology, in particular to a method and apparatus for effects rendering and an electronic device.

### BACKGROUND

As Internet technology develops, users may perform live streaming over a network platform. In the web live streaming, a terminal device of a streamer transmits multimedia contents to terminal devices of audiences in real time through the network. The audiences may browse the live streaming contents shared by the terminal device of the streamer via their own terminal devices and may also interact with the streamer.

### SUMMARY

Embodiments of the present disclosure provide a method and apparatus for effects rendering and an electronic device.

In one aspect, embodiments of the present disclosure provide a method for effects rendering, comprising: displaying a live streaming interface, a first live streaming frame of a sharing user being displayed in the live streaming interface, the first live streaming frame being obtained by applying a first effect to an acquired first video source image, and the first effect including one or more first effect rendering nodes; determining, in response to receiving a request associated with a second effect, a target effect rendering node shared by the first effect and the second effect; obtaining a first frame after processing the first video source image with the target effect rendering node; rendering the first frame with a second effect rendering node of the second effect to obtain a second live streaming frame, wherein the second effect rendering node is different from the target effect rendering node; displaying in the live streaming interface the first live streaming frame corresponding to the first video source image, and displaying the second live streaming frame in a window, wherein the live streaming interface includes the window.

In a second aspect, embodiments of the present disclosure provide an apparatus for effects rendering, comprising: a first display unit, configured to display a live streaming interface, a first live streaming frame of a sharing user being displayed in the live streaming interface, the first live streaming frame being obtained by applying a first effect to an acquired first video source image, and the first effect including one or more first effect rendering nodes; a determining unit, configured to determine, in response to receiving a request associated with a second effect, a target effect rendering node shared by the first effect and the second effect; a first rendering unit, configured to obtain a first frame after processing the first video source image with the target effect rendering node; a second rendering unit, configured to render the first frame with a second effect rendering node of the second effect to obtain a second live streaming frame, wherein the second effect rendering node is different from the target effect rendering node; a second display unit, configured to display in the live streaming interface the first live streaming frame corresponding to the first video source image and displaying the second live streaming frame in a window, wherein the live streaming interface includes the window.

In a third aspect, embodiments of the present disclosure provide an electronic device, comprising: a processor and a memory; wherein the memory stores computer-executable instructions; the processor executes computer-executable instructions stored in the memory, so as to perform the method according to the above first aspect and various possible designs of the first aspect.

In a fourth aspect, embodiments of the present disclosure provide a computer-readable storage medium having computer-executable instructions stored thereon, wherein the computer-executable instructions, when executed by a processor, perform the method according to the above first aspect and various possible designs of the first aspect.

In a fifth aspect, embodiments of the present disclosure provide a computer program product comprising a computer program, the computer program, when executed by a processor, implements the method according to the above first aspect and various possible designs of the first aspect.

According to the method and apparatus for effects rendering and the electronic device provided by the embodiments, a live streaming interface is displayed, in which a first live streaming frame of a sharing user is displayed. The first live streaming frame is obtained by applying a first effect to an acquired first video source image, the first effect includes one or more first effect rendering nodes. In response to receiving a request associated with a second effect, a target effect rendering node shared by the first effect and the second effect is determined. A first frame after processing the first video source image with the target effect rendering node is obtained. The first frame is rendered with a second effect rendering node, different from the target effect rendering node, in the second effect to obtain a second live streaming frame. The first live streaming frame corresponding to the first video source image is displayed in the live streaming interface and the second live streaming frame is displayed in a window, wherein the live streaming interface includes the window.

### BRIEF DESCRIPTION OF THE DRAWINGS

Brief introduction of the drawings required in the following description of the embodiments or the prior art are to be introduced simply below to more clearly explain the technical solutions according to the embodiments of the present disclosure or in the related art. It is obvious that the following drawings only illustrate some embodiments of the present disclosure and those skilled in the art also may obtain other drawings on the basis those illustrated ones without any exercises of inventive work.

FIG. 1 illustrates a schematic diagram of an application scenario;

FIG. 2 illustrates a first schematic flowchart of the method for effects rendering provided by the embodiments of the present disclosure;

FIG. 3 illustrates a second schematic flowchart of the method for effects rendering provided by the embodiments of the present disclosure;

FIG. 4 illustrates a third schematic flowchart of the method for effects rendering provided by the embodiments of the present disclosure;

FIG. 5 illustrates a schematic structural diagram of an apparatus for effects rendering provided by the embodiments of the present disclosure;

FIG. 6 illustrates a structural diagram of an electronic device provided by the embodiments of the present disclosure.

### DETAILED DESCRIPTION OF EMBODIMENTS

For a clearer picture of the objectives, technical solutions and advantages of the embodiments of the present disclosure, the technical solutions in the embodiments of the present disclosure are to be described clearly and completely with reference to the drawings in the embodiments of the present disclosure. It is obvious that the described embodiments are only part of the embodiments of the present disclosure, rather than all of them. All other embodiments obtained by those skilled in the art on the basis of the illustrated embodiments of the present disclosure without any exercises of inventive work fall within the protection scope of the present disclosure.

To enhance visual effects of live streaming contents and enrich live streaming contents, a live streaming party may add effects in the live streaming contents. Usually, before applying the effects to live streaming multimedia information flow, the live streaming party may try the effects.

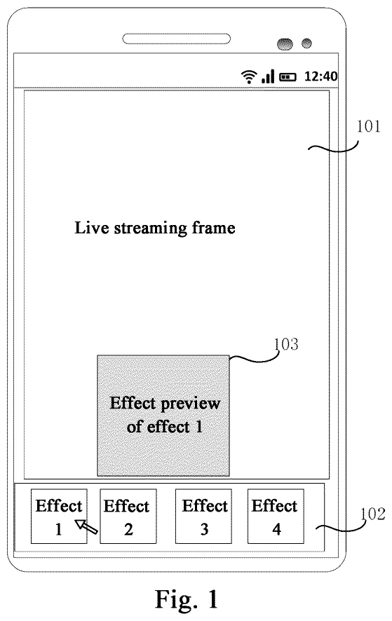

FIG. 1 illustrates a schematic diagram of an application scenario. As shown, a terminal device used by a user (which may be streamer) may display a live streaming interface 101, in which live streaming video streams may be displayed. A list of effects 102 may be displayed on the live streaming interface and may include a plurality of candidate effect tools (“effects” for short) for users to choose and use. The list of effects, for example, may include effect 1, effect 2, effect 3 and effect 4. During the live streaming, the user may select, from the list of effects 102, an effect (such as effect 1) for trial.

During the trial of the effects, a display window may also be displayed on the above client, in addition to the live streaming interface. The live streaming interface may display a live streaming frame pushed to the audience, and an effect displaying graph resulted from applying the effect 1 to the image in the live streaming frame may be displayed in the window 103.

As an implementation, the live streaming frame in the live streaming interface and the effect displaying graph in the window are separately rendered in the above procedure.

In some application scenarios, in the live streaming interface, the live streaming frame may include effects already applied to the live streaming feed and these effects may include the same effect rendering nodes as the effects for trial. In the above implementation, the live streaming frame and the effect displaying graph of the effects for trial are separately rendered. Since it is required to continuously apply the effects to different frames of images and transmit them during the live streaming, it consumes a great deal of resources of the device. Further, it is also required to render the effect displaying graph simultaneously, which intensifies the resource consumption of the device and reduces the frame rate of the live streaming in the event of heavy resource consumption.

In case of rendering with the effects for trial, the method and apparatus for effects rendering and the electronic device provided by the present disclosure reuses an image rendered with the rendering node in the live streaming frame and performs the rendering with the effect rendering nodes for trial on the basis of the reused image, so as to reduce the processing of the repeated data during the rendering of the live streaming frame and the effect displaying graph of the trial effects, lower the total resources consumed by the trial of the effects during the live streaming and advantageously stabilize the frame rate of the live streaming.

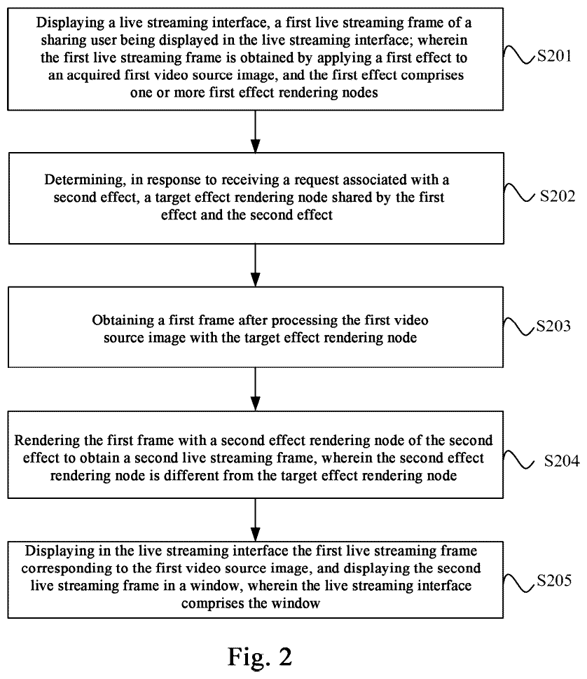

FIG. 2 illustrates a first schematic flowchart of the method for effects rendering provided by the present disclosure. As shown in FIG. 2, the method comprises the following steps of:

S201: displaying a live streaming interface, a first live streaming frame of a sharing user being displayed in the live streaming interface, the first live streaming frame being obtained by applying a first effect to an acquired first video source image, and the first effect including one or more first effect rendering nodes.

In this embodiment, the executive body of the method for effects rendering may be a terminal device, e.g., terminal device of a sharing user (e.g., streamer). The above terminal device may be configured as a video acquisition apparatus for acquiring a first video source. The first video source here, for example, may include a plurality of frames of video images captured by a camera, wherein the plurality of frames of video images include an image of the sharing user. The terminal device may process a plurality of frames of video images of the acquired first video source to further generate a live streaming video feed. The processing of a plurality of frames of video images of the first video source here may include applying a first effect to a plurality of frames of video images of the first video source. The first effect may be an effect pre-selected by the sharing user and applied into the live streaming video feed, or a built-in effect configured for the live streaming video feed by a live streaming client running in the terminal device.

The first effect may include one or more first effect rendering nodes, wherein the one or more first effect rendering nodes, for example, may include filter, beautification, make-up and sticker etc. A rendering sequence of the respective effect rendering nodes in the effects may be determined according to a preset rule for the effect rendering sequence, and the same effect rendering node in different effects comply with the same rendering sequence rule.

In the preset rule for the effect rendering sequence, for example, the filter is the first, the beautification is the second, the make-up is the third, and the sticker is the fourth, in the rendering sequence. As an example, if an effect includes several effect rendering nodes, such as filter, beautification, make-up and sticker, the respective effect rendering nodes are applied to the video image in the following order: filter, beautification, make-up and sticker. If an effect does not include the effect rendering node placed first in the sequence, the rendering node in the second place of the sequence may serve as a priority rendering node in the effect and so on in a similar fashion. For example, when the effect includes beautification, make-up and sticker as the effect rendering nodes, the respective effect rendering nodes are applied to the video image in the following order: beautification, make-up and sticker.

As to each frame of the video image of the above first video source, the frame of the video image may be rendered with a plurality of effect rendering nodes corresponding to the first effect. The above first live streaming frame displays a plurality of frames of video images of the first video source to which the first effect is applied.

S202: in response to receiving a request associated with a second effect, determining a target effect rendering node shared by the first effect and the second effect.

During the live streaming, the sharing user may switch to a second effect. The second effect here may indicate any effects other than the first effect. The list of effects may be displayed in the live streaming interface of the terminal device of the sharing user and the sharing user may select an effect from the list of effects as the second effect and initiate a trial request for the second effect.

The above request associated with the second effect, for example, may include one of: trial request, usage request, parameter-adjusting request etc. The second effect is applied to the first video source image in response to the above request associated with the second effect.

In some application scenarios, the above request associated with the second effect is a trial request. To achieve a better display effect for the effect to be switched, the effect to be switched may be tried at the local terminal, i.e., the trial performance of the effect is presented to the sharing user in the above executive body.

In some application scenarios, the above request associated with the second effect may be a usage request. In these application scenarios, the sharing user may simultaneously apply the first effect and the second effect to the first video source image.

In some application scenarios, the above request associated with the second effect may be a parameter-adjusting request. During a process of applying the first effect to the first video source, the second effect may be chosen to apply to the first video source image and the parameters of the second effect may be adjusted.

Since the terminal device of the sharing user needs to continuously acquire the video images for a long time and process the video images to obtain the live streaming frame, the data to be processed in real time by the terminal device of the sharing user is massive and occupies a large amount of resources of the terminal device. To reduce the further increase of the resources occupied by the request associated with the second effect, a target effect rendering node shared by the first effect and the second effect may be determined.

Specifically, an initial rendering node in the first effect may be compared with an initial rendering node in the second effect; if they are the same, the initial rendering node is a target effect rendering node; after it is determined from comparison that the initial rendering node in the first effect is the same as the initial rendering node in the second effect, a second rendering node in the first effect may be compared with a second rendering node in the second effect; if they are the same, the second rendering node is a target effect rendering node, and so on. In this way, at least one target effect rendering node of the first effect and the second effect may be obtained.

S203: obtaining a first frame after processing the first video source image with the target effect rendering node.

The first video image may be a current frame of the videos source image acquired by the image acquisition device.

Since the first effect is not replaced, the above executive body still needs to apply the first effect to the first video source image.

When the first effect is applied to the first video source image, it is required to apply one or more first effect rendering nodes in the first effect to the first video source image according to their own rendering sequence.

In an example where the first effect A includes filter, beautification and make-up as the first effect rendering nodes, in the above respective first effect rendering nodes, the rendering sequence of the filter is higher than the rendering sequence of the beautification; the rendering sequence of the beautification is higher than the rendering sequence of the make-up; and the rendering sequence of the make-up is higher than the rendering sequence of the sticker. Correspondingly, the respective first effect rendering nodes in the first effect are applied to the first video source image in the following order: first the filter, then the beautification and the make-up in the last.

Specifically, when the first effect A is applied to the first video source image, the first video source image may be input to the filter rendering node. The filter rendering node applies its filter resources and the corresponding parameters to a plurality of pixels of the first video source image, to obtain a second video source image applied with the filter indicated by the filter rendering node; the second video source image then serves as the input of the beautification rendering node. At the beautification rendering node, the beautification resources and parameters of the beautification rendering node are applied to a plurality of pixels of the second video source image to obtain a third video source image applied with the beautification indicated by the beautification rendering node. The third video source image serves as the input of the make-up rendering node. At the make-up rendering node, the make-up resources and parameters of the make-up rendering node are applied to the third video source image to obtain a live streaming frame.

While the first video source image is being rendered using one or more first effect rendering nodes of the first effect, the image obtained after being rendered with the target effect rendering node in the one or more first special rendering nodes is used as the first frame. Still, with respect to the above first effect A, if the target effect rendering node is the filter, the second video source image is the first frame; if the target effect rendering nodes include the filter and the make-up, the third video source image is the first frame.

S204: rendering the first frame with a second effect rendering node of the second effect to obtain a second live streaming frame, wherein the second effect rendering node is different from the target effect rendering node.

The second effect may include a plurality of second effect rendering nodes and the plurality of second effect rendering nodes may include target effect rendering nodes.

As the second effect includes the same target effect rendering nodes as the first effect and these nodes perform the same effect rendering on the first video source image data, the image data obtained by applying the target effect rendering nodes in the first effect to the first video source image data are identical to the image data obtained by applying the target effect rendering nodes in the second effect to the first video source image data. To reduce the resources consumed by the same processing on the same image data, the first frame output by the target effect rendering nodes in the first effect may be copied and the first frame is then rendered using second effect rendering nodes different from the target effect rendering nodes in the second effect, to obtain the second live frame.

S205: displaying in the live streaming interface the first live streaming frame corresponding to the first video source image and displaying the second live streaming frame in a window, wherein the live streaming interface includes the window.

The live streaming interface in the terminal device screen of the sharing user displays the first live streaming frame and the window. The second live streaming frame may be displayed in the above window.

In some application scenarios, the above window is larger than the first live streaming frame in size. In some application scenarios, the above window may cover part of the first live streaming frame.

In this embodiment, in a case that the video source applied with the first effect is live streamed at the sharing user side, upon reception of a request associated with the second effect, the target effect rendering nodes shared by the first effect and the second effect are determined; in the process of obtaining the first live streaming frame by rendering the first video source image with the first effect, the first frame output after the first video source image is applied with the target effect rendering nodes is copied and the first frame is rendered using second effect rendering nodes different from the target effect rendering nodes in the second effect to obtain the second live streaming frame. The first live streaming frame and the window are presented in the live streaming interface and the second live streaming frame is presented in the window. Accordingly, the first live streaming frame is obtained by applying the first effect to the first video source image; in response to the request associated with the second effect, the first frame output by the target effect rendering nodes of the first effect is reused to generate the second live streaming frame. In comparison to obtaining the first live streaming frame by applying a plurality of first effect rendering nodes of the first effect to the first video source image and obtaining the second live streaming frame by applying a plurality of second effect rendering nodes of the second effect to the first video source image separately, the process of rendering the first video source image with the target rendering nodes is omitted in the solution according to this embodiment when the second live streaming frame is generated based on the request associated with the second effect. Therefore, the amount of data to be processed for generating the second live streaming frame is reduced and fewer resources are occupied when the first live streaming frame and the second live streaming frame are generated simultaneously, which is helpful to improve the frame rate decline issue caused by responses to requests associated with other effects during the live streaming.

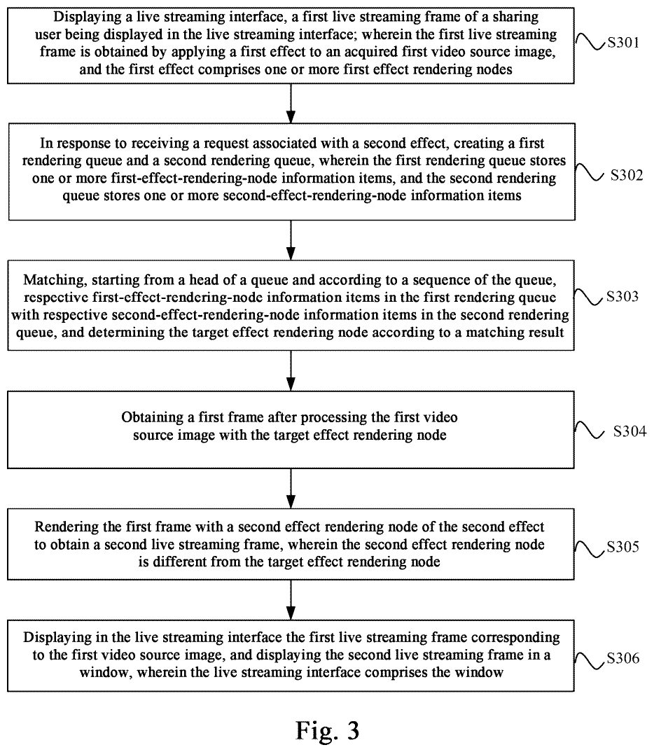

FIG. 3 illustrates a second schematic flowchart of the method for effects rendering provided by the embodiments of the present disclosure. As shown in FIG. 3, the method comprises the following steps:

S301: displaying a live streaming interface, a first live streaming frame of a sharing user being displayed in the live streaming interface; the first live streaming frame being obtained by applying a first effect to an acquired first video source image, the first effect including one or more first effect rendering nodes.

In this embodiment, the executive body of the method for effects rendering may be the terminal device of the sharing user. While using the terminal device for live streaming, the sharing user may apply the first effect to the acquired first video source image to obtain the first live streaming frame. The above terminal device also may push the first live streaming frame to the terminal devices of multiple audiences via the network.

In this embodiment, the detailed implementation of the step S301 may refer to the description of the step S201 in the embodiment shown by FIG. 2 and will not be repeated here.

S302: in response to receiving a request associated with a second effect, creating a first rendering queue and a second rendering queue, wherein the first rendering queue stores one or a plurality of first-effect-rendering-node information items, and the second rendering queue stores one or a plurality of second-effect-rendering-node information items.

Wherein each first-effect-rendering-node information item in the first rendering queue corresponds to one first effect rendering node, and the first-effect-rendering-node information items are arranged in the first rendering queue according to a rendering sequence of the plurality of first effect rendering nodes. Each second-effect-rendering-node information item in the second rendering queue corresponds to one second effect rendering node, and the second-effect-rendering-node information items are arranged in the second rendering queue according to a rendering sequence of a plurality of second effect rendering nodes.

The effect may include a plurality of effect rendering nodes. The rendering sequence of the respective effect rendering nodes in the effects may be determined according to a preset rule for the effect rendering sequence, and the same effect rendering node in different effects comply with the same rendering sequence rule.

Each effect rendering node corresponds to one or more preset effect resources and preset rendering parameters.

The first-effect-rendering-node information item includes one or more of: an identifier of a first effect rendering node, information of an effect resource corresponding to the first effect rendering node and a rendering parameter corresponding to the first effect rendering node.

The second-effect-rendering-node information item includes one or more of: an identifier of a second effect rendering node, information of an effect resource corresponding to the second effect rendering node, and a rendering parameter corresponding to the second effect rendering node.

In accordance with the preset rule for the effect rendering sequence, a plurality of effect rendering nodes in the same effect each has a preset effect rendering sequence. The effect rendering node with a smaller effect rendering sequence number has a priority higher than the effect rendering node with a larger effect rendering sequence number.

After receiving the request associated with the second effect, the above executive body may create a first rendering queue for the first effect and a second rendering queue for the second effect respectively.

In some application scenarios, the above first rendering queue may also be created before the second effect trial request is received. In these application scenarios, after the second effect trial request is received, only the second rendering queue is created.

Schematically, first-effect-rendering-node information item corresponding to a plurality of first effect rendering nodes of the first effect may be stored in the first rendering queue according to an ascending order of the effect rendering sequence number. Second-effect-rendering-node information item corresponding to a plurality of second effect rendering nodes of the second effect may be stored in the second rendering queue according to an ascending order of the effect rendering sequence number.

Information of the effect resources, for example, may include a network or local address for storing the effect resources. The above effect resources may include, but not limited to, one or more of: texture sticker, user interface element, script or code, illumination setting and animation sequence etc.

As an example, if the first effect rendering node is the beautification, the first effect rendering node is identified as an identifier indicating the beautification. The beautification resources, for example, may include a script or code for the beautification. Resource information of the above beautification, for example, may include a storage address of the script or code for whitening. The address here, for example, may be a network address and the rendering parameters corresponding to the beautification, for example, may include whitening level etc.

A plurality of first effect rendering nodes in the first effect and a plurality of second effect rendering nodes in the second effect all comply with the preset rule for the effect rendering sequence. Since the filter effect rendering node is the first in the rendering sequence, the filter effect rendering node, if present in the first effect and the second effect, would be the initial effect rendering node of the first effect and the initial effect rendering node of the second effect.

S303: starting from a head of a queue and according to a sequence of the queue, matching respective first-effect-rendering-node information items in the first rendering queue with respective second-effect-rendering-node information items in the second rendering queue, and determining the target effect rendering node according to a matching result.

The head (first position) of the first rendering queue corresponds to a first effect rendering node with the highest priority in rendering sequence among a plurality of first effect rendering nodes; likewise, the head (first position) of the second rendering queue corresponds to a second effect rendering node with the highest priority in rendering sequence among a plurality of second effect rendering nodes.

Starting from the first position, the first-effect-rendering-node information items in the first rendering queue and the second-effect-rendering-node information items in the second rendering queue may be compared at the same position of the respective queue. If the first-effect-rendering-node information item at the first position of the first rendering queue is identical to the second-effect-rendering-node information item at the first position of the second rendering queue, the first effect rendering node (or the second effect rendering node) corresponding to the first position is the target effect rendering node. After the first effect rendering node corresponding to the first position is determined as the target effect rendering node, the first-effect-rendering-node information item at the second position of the first rendering queue is compared with the second-effect-rendering-node information item at the second position of the second rendering queue; if they are different as indicated by the comparison result, the comparison ends and the first effect rendering node at the first position is output as the target effect rendering node; if they are the same as indicated by the comparison result, the first effect rendering node at the second position is the target effect rendering node. After the first effect rendering node at the second position is determined as the target effect rendering node, the comparison is made between the information item at the third position of the respective queues. In a similar fashion, one or more target effect rendering nodes may be obtained.

It is to be appreciated that for the same image data with same effect resources, if the effect rendering parameters vary, the image data processed by the effect rendering node would also be different. Therefore, in order to determine whether the effect rendering nodes are the same in accordance with the rendering information of the first effect rendering node of the first rendering queue and the rendering information of the second effect rendering node of the second rendering queue, the information of the effect resources and the effect rendering parameters should also be considered.

S304: obtaining a first frame after processing the first video source image with the target effect rendering node.

S305: rendering the first frame with a second effect rendering node of the second effect to obtain a second live streaming frame, wherein the second effect rendering node is different from the target effect rendering node.

S306: displaying in the live streaming interface the first live streaming frame corresponding to the first video source image and displaying the second live streaming frame in a window, wherein the live streaming interface includes the window.

Detailed implementations of the above steps S304-S306 may refer to the related description of the steps S203-S205 in the embodiment shown by FIG. 1 and will not be repeated here.

In this embodiment, the first rendering sequence and the second rendering sequence are created; and according to the effect rendering sequence, the information of the plurality of first effect rendering nodes is stored into the first rendering queue and the information of the plurality of second effect rendering nodes is stored into the second rendering queue; the first-effect-rendering-node information items and the second-effect-rendering-node information items at the same position in the first rendering queue and the second rendering queue may be matched to determine the target effect rendering node. The efficiency for determining the target effect rendering node from the first effect and the second effect may be enhanced.

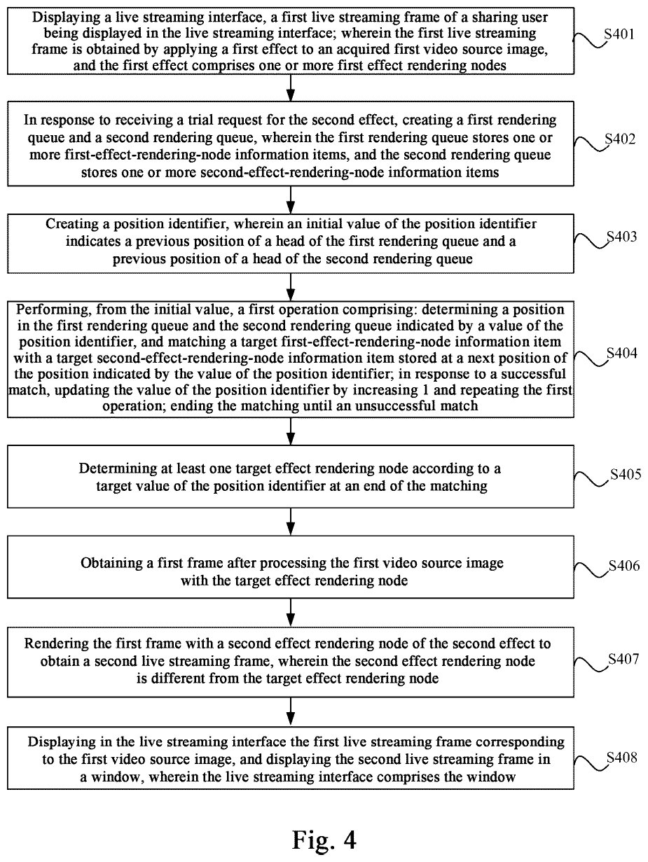

FIG. 4 illustrates a third schematic flowchart of the method for effects rendering provided by the embodiments of the present disclosure. As shown in FIG. 4, the method comprises the following steps:

S401: displaying a live streaming interface, a first live streaming frame of a sharing user being displayed in the live streaming interface, the first live streaming frame being obtained by applying a first effect to an acquired first video source image, and the first effect including one or more first effect rendering nodes.

In this embodiment, the executive body of the method for effects rendering may be the terminal device of the sharing user. While using the terminal device for live streaming, the sharing user may apply the first effect to the acquired first video source image to obtain the first live streaming frame. The above terminal device also may push the first live streaming frame to the terminal devices of multiple audiences via the network.

In this embodiment, the detailed implementation of the step S401 may refer to the description of the step S201 in the embodiment shown by FIG. 2 and will not be repeated here.

S402: in response to receiving a trial request for the second effect, creating a first rendering queue and a second rendering queue, wherein the first rendering queue stores one or a plurality of first-effect-rendering-node information items and the second rendering queue stores one or a plurality of second-effect-rendering-node information items.

Wherein each first-effect-rendering-node information item corresponds to one first effect rendering node, and the first-effect-rendering-node information items are arranged according to a rendering sequence in the first rendering queue; each second-effect-rendering-node information item corresponds to one second effect rendering node, and the second-effect-rendering-node information items is arranged according to a rendering sequence in the second rendering queue.

In this embodiment, the detailed implementation of the above step S402 may refer to the step S302 in the embodiment shown by FIG. 3 and will not be repeated here.

S403: creating a position identifier, wherein an initial value of the position identifier indicates a previous position of a head of a first rendering queue and a previous position of a head of a second rendering queue.

S404: performing, from the initial value, a first operation comprising: determining a position in a first rendering queue and a second rendering queue indicated by a value of the position identifier, and matching a target first-effect-rendering-node information item with a target second-effect-rendering-node information item stored at a next position of the position indicated by the value of the position identifier; in response to a successful match, updating the value of the position identifier by increasing 1 and repeating the first operation; ending the matching until an unsuccessful match.

S405: determining at least one target effect rendering node according to a target value of the position identifier at an end of the matching.

A value of the above position identifier is used for indicating a position in the queue and may be altered. An initial value of the above position identifier, for example, may be 0 and the initial value may indicate a previous position of the head of the first rendering queue and a previous position of the head of the second rendering queue.

When performing the first operation for the first time, the initial value of the position identifier is pointed to a previous position of the head of the first rendering queue and a previous position of the head of the second rendering queue. A next position of the position indicated by the initial value of the position identifier is the head of the first rendering queue and the head of the second rendering queue. When performing the first operation for the first time, the target first-effect-rendering-node information item stored at the head of the first rendering queue may be matched with the target second-effect-rendering-node information item stored at the head of the second rendering queue. For example, the effect identifier, the address information of the effect resource and the effect parameter indicated by the target first-effect-rendering-node information item may be compared with the effect identifier, the address information of the effect resource and the effect parameter indicated by the target second-effect-rendering-node information item separately. When the respective comparison results of the effect identifier, the address information of the effect resource and the effect parameter all indicate the same, the match between the target first-effect-rendering-node information item at the head of the first rendering queue and the target second-effect-rendering-node information item at the head of the second rendering queue is successful; otherwise, the match fails.

After a successful match between the target first-effect-rendering-node information item corresponding to the head of the first rendering queue and the target second-effect-rendering-node information item corresponding to the head of the second rendering queue, the value of the position identifier may be increased by 1. A value (e.g., “1”) of the position identifier plus one indicates the heads of the first rendering queue and the second rendering queue. The next position of the head of the queue is a second position, which corresponds to the second one of the first-effect-rendering-node information items of the first rendering queue and the second one of the second-effect-rendering-node information items of the second rendering queue.

Correspondingly, the second one of the first-effect-rendering-node information items in the first rendering queue may be matched with the second one of the second-effect-rendering-node information items in the second rendering queue; in case of a successful match, the value of the position identifier is added by 1 and the value of the position identifier is pointed to a second position.

The above operation is repeated until an unsuccessful match.

At the end of the matching, the value of the position identifier no longer changes. The value of the position identifier may be used as a target value, and the target effect rendering node may be determined in accordance with a position of the first effect rendering node, in the first rendering queue or the second rendering queue, as indicated by the target value. For example, when the target value is 1, the first effect rendering node corresponding to the first-effect-rendering-node information items in the first rendering queue is the target effect rendering node. If the target value is 2, the second effect rendering node indicated by the first-effect-rendering-node information item and the second-effect-rendering-node information item in the second rendering queue is the target effect rendering node.

In this embodiment, the position identifier is configured and the target effect rendering node is determined via the value of the position identifier in accordance with the effect rendering information in the first rendering queue or the second rendering queue.

S406: obtaining a first frame after processing the first video source image with the target effect rendering node.

In some implementations, the above step S406 includes the following steps:
first, rendering, from a head of a queue and in sequence, a first video source image with a plurality of first effect rendering nodes corresponding to the first-effect-rendering-node information items in a first rendering queue;
then, in response to detecting that rendering proceeds to a last target effect rendering node indicated by the target value, using an image output by the last target effect rendering node as a first frame, copying the first frame, and generating the second live streaming frame with the copied first frame; and
in the end, using continuously first effect rendering nodes corresponding to subsequent first-effect-rendering-node information items in the first rendering queue, to render the first frame, so as to obtain the live streaming frame.

Within the first rendering queue, information of every first effect rendering node is extracted in sequence from the head to the tail of the queue; and then the first video source image is processed with the first effect rendering node indicated by the information of every first effect rendering node extracted from the above first rendering queue.

Every time a piece of first-effect-rendering-node information item is extracted from the first rendering queue, it is determined whether the position of the extracted first-effect-rendering-node information item in the first rendering queue is the position indicated by the target value of the position identifier. If it is determined that the position of the extracted first-effect-rendering-node information item in the first rendering queue is the position indicated by the target value of the position identifier, the first effect rendering node indicated by the first-effect-rendering-node information item is the last target effect rendering node.

After the input image is processed with the last target effect rendering node, the first frame obtained from the above processing is copied. The copied first frame is used for generating the second live streaming frame.

In these implementations, the target value of the position identifier indicates the information of one or more target effect rendering nodes; in the process of obtaining the live streaming frame by rendering the first video source image with a plurality of first effect rendering nodes corresponding to the first rendering queue, it is determined whether the first frame should be copied at present with the aid of the target value of the position identifier, and the copied first frame is used to generate the second live streaming frame in response to the request associated with the second effect. Accordingly, the efficiency for obtaining the first frame in the process of rendering the first video source image with a plurality of first effect rendering nodes of the first effect is improved and the second live streaming frame can be quickly and accurately generated.

S407: rendering the first frame with a second effect rendering node of the second effect to obtain a second live streaming frame, wherein the second effect rendering node is different from the target effect rendering node.

In some implementations, the above step S407 includes the following steps:
first, deleting from the second rendering queue the second-effect-rendering-node information items corresponding to the target effect rendering node to obtain a target second rendering queue; and
then, rendering the first frame with a second effect rendering node indicated by second-effect-rendering-node information item in the target second rendering queue, to obtain the second live streaming frame

In these implementations, after the target value of the position identifier is obtained, the second-effect-rendering-node information items (information of the target effect rendering nodes), from the head of the queue to the position indicated by the target value, may be deleted from the original second rendering queue, to obtain a target second rendering queue. The obtained target second rendering queue includes the information corresponding to the second effect rendering nodes different from the target effect rendering nodes. Respective second effect rendering nodes in the target second rendering queue may be directly used to render the first frame, so as to obtain the second live streaming frame. This facilitates the quick and effective generation of the second live streaming frame.

In these implementations, since the first frame input by the second rendering queue is obtained using the target value of the position identifier, the reused first frame may be accurately obtained from the process of rendering the first video source image with the first effect, thereby enhancing the accuracy for generating the second live streaming frame.

S408: displaying in the live streaming interface the first live streaming frame corresponding to the first video source image and displaying the second live streaming frame in a window, wherein the live streaming interface includes the window.

In this embodiment, the position identifier is created and a value of the position identifier indicates the information corresponding to the target effect rendering nodes in the first rendering queue and the second rendering queue, such that in the process of obtaining the first live streaming frame by rendering the first video source image with a plurality of first effect rendering nodes corresponding to the first rendering queue, it is determined whether the first frame should be copied at present with the aid of the target value of the position identifier, and the copied first frame is used to generate the second live streaming frame. Accordingly, the efficiency for determining the first image is improved and the accuracy for generating the second live streaming frame by reusing the target effect rendering nodes is also enhanced.

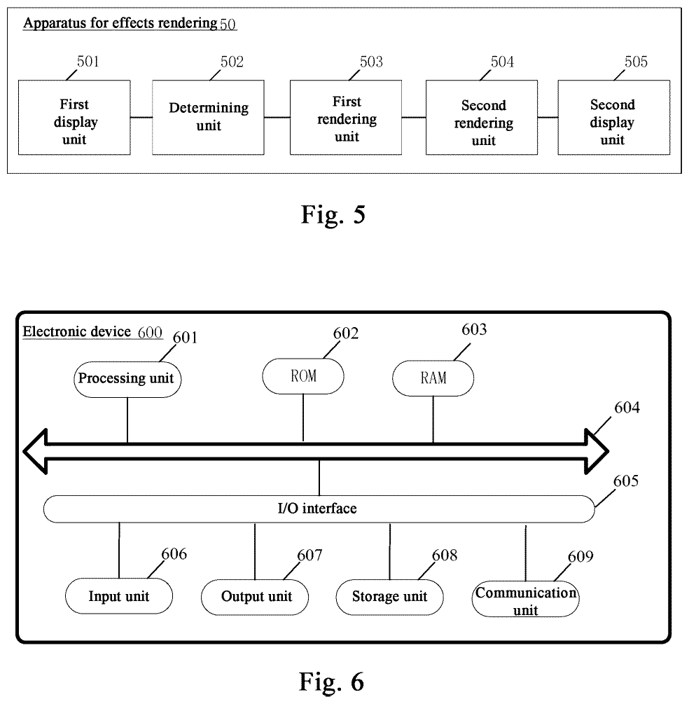

In correspondence to the method for effects rendering according to the embodiments of FIGS. 2-4, FIG. 5 illustrates a schematic structural diagram of an apparatus for effects rendering provided by the embodiments of the present disclosure. For the sake of description, only the parts related to the embodiments of present disclosure are demonstrated. With reference to FIG. 5, the apparatus 50 comprises: a first display unit 501, a determining unit 502, a first rendering unit 503, a second rendering unit 504 and a second display unit 505, wherein:
the first display unit 501 is used for displaying a live streaming interface, a first live streaming frame of a sharing user being displayed in the live streaming interface, the first live streaming frame being obtained by applying a first effect to an acquired first video source image, and the first effect including one or more first effect rendering nodes;
the determining unit 502 is configured to determine, in response to receiving a request associated with a second effect, a target effect rendering node shared by the first effect and the second effect;
the first rendering unit 503 is configured to obtain a first frame after processing the first video source image with the target effect rendering node;
the second rendering unit 504 is configured to render the first frame with a second effect rendering node of the second effect to obtain a second live streaming frame, wherein the second effect rendering node is different from the target effect rendering node; and
the second display unit 505 is configured to display in the live streaming interface the first live streaming frame corresponding to the first video source image and displaying the second live streaming frame in a window, wherein the live streaming interface includes the window.

### In Some Embodiments, the Determining Unit 502 Is Further Configured to:

create a first rendering queue and a second rendering queue, wherein the first rendering queue stores one or a plurality of first-effect-rendering-node information items, each first-effect-rendering-node information item corresponds to one first effect rendering node, and the first-effect-rendering-node information items are arranged according to a rendering sequence of the plurality of first effect rendering nodes; the second rendering queue stores one or a plurality of second-effect-rendering-node information items, each second-effect-rendering-node information item corresponds to one second effect rendering node, and the second-effect-rendering-node information items are arranged according to a rendering sequence of a plurality of second effect rendering nodes; and
match, from a head of a queue and according to a sequence of the queue, respective first-effect-rendering-node information items in a first rendering queue with respective second-effect-rendering-node information items in a second rendering queue, and determine the target effect rendering node according to a matching result.

In some embodiments, the apparatus 50 also comprises a unit for creating position identifier (not shown in the drawings), which is provided for creating a position identifier, wherein an initial value of the position identifier indicates a previous position of a head of a first rendering queue and a previous position of a head of a second rendering queue.

The determining unit 502 is further configured to:
perform, from the initial value, a first operation comprising:
   determining a position in a first rendering queue and a second rendering queue indicated by a value of the position identifier and matching a target first-effect-rendering-node information item with a target second-effect-rendering-node information item stored at a next position of a position indicated by a value of the position identifier; in case of a successful match, updating the value of the position identifier by increasing 1 and repeating the first operation; ending the matching until an unsuccessful match;
   determining at least one target effect rendering node according to a target value of the position identifier at an end of the matching.

In some embodiments, the first rendering unit 503 is further configured to:
render, from a head of a queue and in sequence, a first video source image with a plurality of first effect rendering nodes corresponding to the first-effect-rendering-node information items in a first rendering queue;
use, in response to detecting that rendering proceeds to a last target effect rendering node indicated by the target value, an image output by the last target effect rendering node as a first frame, copy the first frame, and generate the second live streaming frame with the copied first frame; and
use continuously first effect rendering nodes corresponding to subsequent first-effect-rendering-node information items in the first rendering queue, to render the first frame, so as to obtain the first live streaming frame.

In some embodiments, the second rendering unit 504 is further configured to:
delete from the second rendering queue a second-effect-rendering-node information item corresponding to the target effect rendering node to obtain a target second rendering queue; and
render the first frame with a second effect rendering node indicated by the second-effect-rendering-node information item in the target second rendering queue, to obtain the second live streaming frame.

In some embodiments, the first-effect-rendering-node information item includes one or more of: an identifier of a first effect rendering node, information of an effect resource corresponding to the first effect rendering node and a rendering parameter corresponding to the first effect rendering node.

The second-effect-rendering-node information item includes one or more of: an identifier of a second effect rendering node, information of an effect resource corresponding to the second effect rendering node, and a rendering parameter corresponding to the second effect rendering node.

In order to implement the above embodiments, the present disclosure also provides an electronic device.

FIG. 6 illustrates a structural diagram of an electronic device 600 provided by the embodiments of the present disclosure. The electronic device 600 may be a terminal device or a server, wherein the terminal device may include, but not limited to, mobile terminals, such as mobile phones, notebooks, digital broadcast receivers, PDA (Personal Digital Assistant), PAD (Portable Android Device), PMP (Portable Multimedia Player) and vehicle terminals (such as car navigation terminal) and fixed terminals, e.g., digital TVs and desktop computers etc. The electronic device shown in FIG. 6 is just an example and will not put any restrictions on the functions and application ranges of the embodiments of the present disclosure.

According to FIG. 6, the electronic device 600 may include a processing unit (e.g., central processor, graphic processor and the like) 601, which can execute various suitable actions and processing based on the programs stored in the read-only memory (ROM) 602 or programs loaded in the random-access memory (RAM) 603 from a storage unit 608. The RAM 603 can also store all kinds of programs and data required by the operations of the electronic device 600. Processing unit 601, ROM 602 and RAM 603 are connected to each other via a bus 604. The input/output (I/O) interface 605 is also connected to the bus 604.

Usually, input unit 606 (including touch screen, touchpad, keyboard, mouse, camera, microphone, accelerometer, gyroscope and like) and output unit 607 (including liquid crystal display (LCD), speaker and vibrator etc.), storage unit 608 (including tape and hard disk etc.) and communication unit 609 may be connected to the I/O interface 605. The communication unit 609 may allow the electronic device 600 to exchange data with other devices through wired or wireless communications. Although FIG. 6 illustrates the electronic device 600 having various units, it is to be understood that it is not a prerequisite to implement or provide all illustrated units. Alternatively, more or less units may be implemented or provided.

In particular, in accordance with embodiments of the present disclosure, the process depicted above with reference to the flowchart may be implemented as computer software programs. For example, the embodiments of the present disclosure include a computer program product including computer programs carried on a non-transitory computer readable medium, wherein the computer programs include program codes for executing the method demonstrated by the flowchart. In these embodiments, the computer programs may be loaded and installed from networks via the communication unit 609, or installed from the storage unit 608, or installed from the ROM 602. The computer programs, when executed by the processing unit 601, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The above computer readable medium may be included in the aforementioned electronic device or stand-alone without fitting into the electronic device.

The above computer readable medium bears one or more programs. When the above one or more programs are executed by the electronic device, the electronic device is enabled to execute the method illustrated by the above embodiments.

Computer program instructions for executing operations of the present disclosure are written in one or more programming languages or combinations thereof. The above programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, the first obtaining unit also may be described as “a unit for obtaining at least two Internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In a first aspect, in accordance with one or more embodiments of the present disclosure, there is provided a method for effects rendering, comprising: displaying a live streaming interface, a first live streaming frame of a sharing user being displayed in the live streaming interface, the first live streaming frame being obtained by applying a first effect to an acquired first video source image, and the first effect including one or more first effect rendering nodes; in response to receiving a request associated with a second effect, determining a target effect rendering node shared by the first effect and the second effect; obtaining a first frame after processing the first video source image with the target effect rendering node; rendering the first frame with a second effect rendering node of the second effect to obtain a second live streaming frame, wherein the second effect rendering node is different from the target effect rendering node; and displaying in the live streaming interface the first live streaming frame corresponding to the first video source image, and displaying the second live streaming frame in a window, wherein the live streaming interface includes the window.

In accordance with one or more embodiments of the present disclosure, the determining the target effect rendering node shared by the first effect and the second effect in response to receiving the request associated with the second effect includes: creating a first rendering queue and a second rendering queue, wherein the first rendering queue stores one or a plurality of first-effect-rendering-node information items, each first-effect-rendering-node information item corresponds to one first effect rendering node, and the first-effect-rendering-node information items are arranged according to a rendering sequence of the plurality of first effect rendering nodes; the second rendering queue stores one or a plurality of second-effect-rendering-node information items, each second-effect-rendering-node information item corresponds to one second effect rendering node, and the second-effect-rendering-node information items are arranged according to a rendering sequence of a plurality of second effect rendering nodes; matching, from a head of a queue and according to a sequence of the queue, respective first-effect-rendering-node information items in the first rendering queue with respective second-effect-rendering-node information items in the second rendering queue, and determining the target effect rendering node according to a matching result.

In accordance with one or more embodiments of the present disclosure, the method further comprises: creating a position identifier, wherein an initial value of the position identifier indicates a previous position of a head of the first rendering queue and a previous position of a head of the second rendering queue; and wherein matching, starting from the head of the queue and according to the sequence of the queue, respective first-effect-rendering-node information items in the first rendering queue with respective second-effect-rendering-node information items in the second rendering queue, and determining the target effect rendering node according to the matching result include: performing, from the initial value, a first operation comprising: determining a position in the first rendering queue and the second rendering queue indicated by a value of the position identifier, and matching a target first-effect-rendering-node information item with a target second-effect-rendering-node information item stored at a next position of the position indicated by the value of the position identifier; in response to a successful match, updating the value of the position identifier by increasing 1 and repeating the first operation; ending the matching until an unsuccessful match; determining at least one target effect rendering node according to a target value of the position identifier at an end of the matching.

In accordance with one or more embodiments of the present disclosure, the obtaining the first frame after processing the first video source image with the target effect rendering node includes: rendering, starting from a head of a queue and in sequence, the first video source image with the first effect rendering nodes corresponding to the plurality of first-effect-rendering-node information items in the first rendering queue; in response to detecting that the rendering proceeds to a last target effect rendering node indicated by the target value, using an image output by the last target effect rendering node as the first frame, and copying the first frame, wherein the copied first frame is used for generating the second live streaming frame; and using continuously the first effect rendering nodes corresponding to subsequent first-effect-rendering-node information items in the first rendering queue to render the first frame, so as to obtain the first live streaming frame.

In accordance with one or more embodiments of the present disclosure, the rendering the first frame with the second effect rendering node of the second effect to obtain the second live streaming frame includes: deleting, from the second rendering queue, a second-effect-rendering-node information item corresponding to the target effect rendering node, to obtain a target second rendering queue; rendering the first frame with a second effect rendering node indicated by a second-effect-rendering-node information item in the target second rendering queue, to obtain the second live streaming frame.

In accordance with one or more embodiments of the present disclosure, the first-effect-rendering-node information item includes one or more of: an identifier of a first effect rendering node, information of an effect resource corresponding to the first effect rendering node, and a rendering parameter corresponding to the first effect rendering node; the second-effect-rendering-node information item includes one or more of: an identifier of a second effect rendering node, information of an effect resource corresponding to the second effect rendering node, and a rendering parameter corresponding to the second effect rendering node.

In a second aspect, according to one or more embodiments of the present disclosure, there is provided an apparatus for effects rendering, comprising: a first display unit, configured to display a live streaming interface, a first live streaming frame of a sharing user being displayed in the live streaming interface, the first live streaming frame being obtained by applying a first effect to an acquired first video source image, and and the first effect including one or more first effect rendering nodes; a determining unit, configured to determine, in response to receiving a request associated with a second effect, a target effect rendering node shared by the first effect and the second effect; a first rendering unit, configured to obtain a first frame after processing the first video source image with the target effect rendering node; a second rendering unit, configured to render the first frame with a second effect rendering node of the second effect to obtain a second live streaming frame, wherein the second effect rendering node is different from the target effect rendering node; a second display unit, configured to display in the live streaming interface the first live streaming frame corresponding to the first video source image and displaying the second live streaming frame in a window, wherein the live streaming interface includes the window.

In accordance with one or more embodiments of the present disclosure, the determining unit is further configured to:
create a first rendering queue and a second rendering queue, wherein the first rendering queue stores one or a plurality of first-effect-rendering-node information items, each first-effect-rendering-node information item corresponds to one first effect rendering node, and the plurality of first-effect-rendering-node information items are arranged according to a rendering sequence of the plurality of first effect rendering nodes; the second rendering queue stores one or a plurality of second-effect-rendering-node information items, each second-effect-rendering-node information item corresponds to one second effect rendering node, and the plurality of second-effect-rendering-node information items are arranged according to a rendering sequence of a plurality of second effect rendering nodes; and
match, from a head of a queue and according to a sequence of the queue, respective first-effect-rendering-node information items in a first rendering queue with respective second-effect-rendering-node information items in a second rendering queue, and determine the target effect rendering node according to a matching result.

In accordance with one or more embodiments of the present disclosure, the apparatus further comprises a unit for creating position identifier, which is configured to create a position identifier, wherein an initial value of the position identifier indicates a previous position of a head of a first rendering queue and a previous position of a head of a second rendering queue. The determining unit is further configured to: perform, from the initial value, a first operation including: determining a position in a first rendering queue and a second rendering queue indicated by a value of the position identifier and matching a target first-effect-rendering-node information item with a target second-effect-rendering-node information item stored at a next position of a position indicated by a value of the position identifier; in case of a successful match, updating the value of the position identifier by increasing 1 and repeating the first operation; ending the matching until an unsuccessful match; determining at least one target effect rendering node according to a target value of the position identifier at an end of the matching.

In accordance with one or more embodiments of the present disclosure, the first rendering unit is further configured to: render, from a head of a queue and in sequence, a first video source image with a plurality of first effect rendering nodes corresponding to the first-effect-rendering-node information items in a first rendering queue; in response to detecting that rendering proceeds to a last target effect rendering node indicated by the target value, using an image output by the last target effect rendering node as a first frame, copying the first frame, and generating the second live streaming frame with the copied first frame; and using continuously first effect rendering nodes corresponding to subsequent first-effect-rendering-node information items in the first rendering queue, to render the first frame, so as to obtain the first live streaming frame.

In accordance with one or more embodiments of the present disclosure, the second rendering unit is further configured to: delete from the second rendering queue the second-effect-rendering-node information item corresponding to the target effect rendering node to obtain a target second rendering queue; and render the first frame with a second effect rendering node indicated by the second-effect-rendering-node information item in the target second rendering queue, to obtain the second live streaming frame.

In accordance with one or more embodiments of the present disclosure, the first-effect-rendering-node information item includes one or more of: an identifier of a first effect rendering node, information of an effect resource corresponding to the first effect rendering node and a rendering parameter corresponding to the first effect rendering node. The second-effect-rendering-node information item includes one or more of: an identifier of a second effect rendering node, information of an effect resource corresponding to the second effect rendering node, and a rendering parameter corresponding to the second effect rendering node.

In a third aspect, according to one or more embodiments of the present disclosure, there is provided an electronic device, comprising: at least one processor and a memory; wherein the memory stores computer-executable instructions. The at least one processor executes the computer-executable instructions stored in the memory, so as to implement the method according to the first aspect and various possible designs of the first aspect.

In a fourth aspect, according to one or more embodiments of the present disclosure, there is provided a computer-readable storage medium having computer-executable instructions stored thereon, which computer-executable instructions, when executed by a processor, implement the method according to the first aspect and various possible designs of the first aspect.

In a fifth aspect, according to one or more embodiments of the present disclosure, there is provided a computer program product, comprising computer programs, which computer programs, when executed by a processor, implement the method according to the first aspect and various possible designs of the first aspect.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion comprises some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. A method for effects rendering, comprising:
displaying a live streaming interface, a first live streaming frame of a sharing user being displayed in the live streaming interface; the first live streaming frame being obtained by applying a first effect to an acquired first video source image, and the first effect comprising one or more first effect rendering nodes;
determining, in response to receiving a request associated with a second effect, a target effect rendering node shared by the first effect and the second effect;
obtaining a first frame after processing the first video source image with the target effect rendering node;
rendering the first frame with a second effect rendering node of the second effect to obtain a second live streaming frame, the second effect rendering node being different from the target effect rendering node; and
displaying in the live streaming interface the first live streaming frame corresponding to the first video source image, and displaying the second live streaming frame in a window, the live streaming interface comprising the window.

2. The method of claim 1, wherein the determining, in response to receiving the request associated with the second effect, the target effect rendering node shared by the first effect and the second effect comprises:
creating a first rendering queue and a second rendering queue, the first rendering queue storing one or a plurality of first-effect-rendering-node information items, each first-effect-rendering-node information item corresponding to one first effect rendering node, the plurality of first-effect-rendering-node information items being arranged according to a rendering sequence of corresponding first effect rendering nodes, the second rendering queue storing one or a plurality of second-effect-rendering-node information items, each second-effect-rendering-node information item corresponding to one second effect rendering node, and a plurality of second-effect-rendering-node information items being arranged according to a rendering sequence of corresponding second effect rendering nodes; and
matching, starting from a head of a queue and according to a sequence of the queue, respective first-effect-rendering-node information items in the first rendering queue with respective second-effect-rendering-node information items in the second rendering queue, and determining the target effect rendering node according to a matching result.

3. The method of claim 2, further comprising:
creating a position identifier, an initial value of the position identifier indicating a previous position of a head of the first rendering queue and a previous position of a head of the second rendering queue; and
wherein matching, starting from the head of the queue and according to the sequence of the queue, respective first-effect-rendering-node information items in the first rendering queue with respective second-effect-rendering-node information items in the second rendering queue, and determining the target effect rendering node according to the matching result comprises:
performing, from the initial value, a first operation comprising:
determining a position in the first rendering queue and the second rendering queue indicated by a value of the position identifier, and matching a target first-effect-rendering-node information item with a target second-effect-rendering-node information item stored at a next position of the position indicated by the value of the position identifier; in response to a successful match, updating the value of the position identifier by increasing 1 and repeating the first operation; ending the matching until an unsuccessful match; and
determining at least one target effect rendering node according to a target value of the position identifier at an end of the matching.

4. The method of claim 3, wherein the obtaining the first frame after processing the first video source image with the target effect rendering node comprises:
rendering, starting from a head of a queue and in sequence, the first video source image with the first effect rendering nodes corresponding to the plurality of first-effect-rendering-node information items in the first rendering queue;
in response to detecting that the rendering proceeds to a last target effect rendering node indicated by the target value, using an image output by the last target effect rendering node as the first frame, and copying the first frame, the copied first frame being used for generating the second live streaming frame; and
using continuously the first effect rendering nodes corresponding to subsequent first-effect-rendering-node information items in the first rendering queue to render the first frame, so as to obtain the first live streaming frame.

5. The method of claim 2, wherein the rendering the first frame with the second effect rendering node of the second effect to obtain the second live streaming frame comprises:
deleting, from the second rendering queue, a second-effect-rendering-node information item corresponding to the target effect rendering node, to obtain a target second rendering queue; and
rendering the first frame with a second effect rendering node indicated by a second-effect-rendering-node information item in the target second rendering queue, to obtain the second live streaming frame.

6. The method of claim 3, wherein the first-effect-rendering-node information item comprises one or more of:
an identifier of a first effect rendering node, information of an effect resource corresponding to the first effect rendering node, or a rendering parameter corresponding to the first effect rendering node.

7. The method of claim 3, wherein the second-effect-rendering-node information item comprises one or more of:
an identifier of a second effect rendering node, information of an effect resource corresponding to the second effect rendering node, or a rendering parameter corresponding to the second effect rendering node.

8. An electronic device, comprising: a processor and a memory;
wherein the memory stores computer-executable instructions, the computer-executable instructions, when executed by the processor, cause the electronic device to:
display a live streaming interface, a first live streaming frame of a sharing user being displayed in the live streaming interface; the first live streaming frame being obtained by applying a first effect to an acquired first video source image, and the first effect comprising one or more first effect rendering nodes;
determine, in response to receiving a request associated with a second effect, a target effect rendering node shared by the first effect and the second effect;
obtain a first frame after processing the first video source image with the target effect rendering node;
render the first frame with a second effect rendering node of the second effect to obtain a second live streaming frame, the second effect rendering node being different from the target effect rendering node; and
display in the live streaming interface the first live streaming frame corresponding to the first video source image, and display the second live streaming frame in a window, the live streaming interface comprising the window.

9. The electronic device of claim 8, wherein the computer-executable instructions causing the electronic device to determine, in response to receiving the request associated with the second effect, the target effect rendering node shared by the first effect and the second effect further cause the electronic device to:
create a first rendering queue and a second rendering queue, the first rendering queue storing one or a plurality of first-effect-rendering-node information items, each first-effect-rendering-node information item corresponding to one first effect rendering node, the plurality of first-effect-rendering-node information items being arranged according to a rendering sequence of corresponding first effect rendering nodes, the second rendering queue storing one or a plurality of second-effect-rendering-node information items, each second-effect-rendering-node information item corresponding to one second effect rendering node, and a plurality of second-effect-rendering-node information items being arranged according to a rendering sequence of corresponding second effect rendering nodes; and
match, starting from a head of a queue and according to a sequence of the queue, respective first-effect-rendering-node information items in the first rendering queue with respective second-effect-rendering-node information items in the second rendering queue, and determine the target effect rendering node according to a matching result.

10. The electronic device of claim 9, wherein the computer-executable instructions further cause the electronic device to:
create a position identifier, an initial value of the position identifier indicating a previous position of a head of the first rendering queue and a previous position of a head of the second rendering queue; and
wherein the computer-executable instructions causing the electronic device to match, starting from the head of the queue and according to the sequence of the queue, respective first-effect-rendering-node information items in the first rendering queue with respective second-effect-rendering-node information items in the second rendering queue, and determining the target effect rendering node according to the matching result further cause the electronic device to:
perform, from the initial value, a first operation comprising:
determining a position in the first rendering queue and the second rendering queue indicated by a value of the position identifier, and matching a target first-effect-rendering-node information item with a target second-effect-rendering-node information item stored at a next position of the position indicated by the value of the position identifier; in response to a successful match, updating the value of the position identifier by increasing 1 and repeating the first operation; ending the matching until an unsuccessful match; and
determine at least one target effect rendering node according to a target value of the position identifier at an end of the matching.

11. The electronic device of claim 10, wherein the computer-executable instructions causing the electronic device to obtain the first frame after processing the first video source image with the target effect rendering node further cause the electronic device to:
render, starting from a head of a queue and in sequence, the first video source image with the first effect rendering nodes corresponding to the plurality of first-effect-rendering-node information items in the first rendering queue;
in response to detecting that the rendering proceeds to a last target effect rendering node indicated by the target value, use an image output by the last target effect rendering node as the first frame, and copy the first frame, the copied first frame being used for generating the second live streaming frame; and
use continuously the first effect rendering nodes corresponding to subsequent first-effect-rendering-node information items in the first rendering queue to render the first frame, so as to obtain the first live streaming frame.

12. The electronic device of claim 9, wherein the computer-executable instructions causing the electronic device to render the first frame with the second effect rendering node of the second effect to obtain the second live streaming frame further cause the electronic device to:
delete, from the second rendering queue, a second-effect-rendering-node information item corresponding to the target effect rendering node, to obtain a target second rendering queue; and
render the first frame with a second effect rendering node indicated by a second-effect-rendering-node information item in the target second rendering queue, to obtain the second live streaming frame.

13. The electronic device of claim 10, wherein the first-effect-rendering-node information item comprises one or more of:
an identifier of a first effect rendering node, information of an effect resource corresponding to the first effect rendering node, or a rendering parameter corresponding to the first effect rendering node.

14. The electronic device of claim 10, wherein the second-effect-rendering-node information item comprises one or more of:
an identifier of a second effect rendering node, information of an effect resource corresponding to the second effect rendering node, or a rendering parameter corresponding to the second effect rendering node.

15. A non-transitory computer-readable storage medium having computer-executable instructions stored thereon, wherein the computer-executable instructions, when executed by a processor, cause the processor to:
display a live streaming interface, a first live streaming frame of a sharing user being displayed in the live streaming interface; the first live streaming frame being obtained by applying a first effect to an acquired first video source image, and the first effect comprising one or more first effect rendering nodes;
determine, in response to receiving a request associated with a second effect, a target effect rendering node shared by the first effect and the second effect;
obtain a first frame after processing the first video source image with the target effect rendering node;
render the first frame with a second effect rendering node of the second effect to obtain a second live streaming frame, the second effect rendering node being different from the target effect rendering node; and
display in the live streaming interface the first live streaming frame corresponding to the first video source image, and display the second live streaming frame in a window, the live streaming interface comprising the window.

16. The non-transitory computer-readable storage medium of claim 15, wherein the computer-executable instructions causing the processor to determine, in response to receiving the request associated with the second effect, the target effect rendering node shared by the first effect and the second effect further cause the processor to:
create a first rendering queue and a second rendering queue, the first rendering queue storing one or a plurality of first-effect-rendering-node information items, each first-effect-rendering-node information item corresponding to one first effect rendering node, the plurality of first-effect-rendering-node information items being arranged according to a rendering sequence of corresponding first effect rendering nodes, the second rendering queue storing one or a plurality of second-effect-rendering-node information items, each second-effect-rendering-node information item corresponding to one second effect rendering node, and a plurality of second-effect-rendering-node information items being arranged according to a rendering sequence of corresponding second effect rendering nodes; and
match, starting from a head of a queue and according to a sequence of the queue, respective first-effect-rendering-node information items in the first rendering queue with respective second-effect-rendering-node information items in the second rendering queue, and determine the target effect rendering node according to a matching result.

17. The non-transitory computer-readable storage medium of claim 16, wherein the computer-executable instructions further cause the processor to:
create a position identifier, an initial value of the position identifier indicating a previous position of a head of the first rendering queue and a previous position of a head of the second rendering queue; and
wherein the computer-executable instructions causing the processor to match, starting from the head of the queue and according to the sequence of the queue, respective first-effect-rendering-node information items in the first rendering queue with respective second-effect-rendering-node information items in the second rendering queue, and determining the target effect rendering node according to the matching result further cause the processor to:
perform, from the initial value, a first operation comprising:
determining a position in the first rendering queue and the second rendering queue indicated by a value of the position identifier, and matching a target first-effect-rendering-node information item with a target second-effect-rendering-node information item stored at a next position of the position indicated by the value of the position identifier; in response to a successful match, updating the value of the position identifier by increasing 1 and repeating the first operation; ending the matching until an unsuccessful match; and
determine at least one target effect rendering node according to a target value of the position identifier at an end of the matching.

18. The non-transitory computer-readable storage medium of claim 17, wherein the computer-executable instructions causing the processor to obtain the first frame after processing the first video source image with the target effect rendering node further cause the processor to:
render, starting from a head of a queue and in sequence, the first video source image with the first effect rendering nodes corresponding to the plurality of first-effect-rendering-node information items in the first rendering queue;
in response to detecting that the rendering proceeds to a last target effect rendering node indicated by the target value, use an image output by the last target effect rendering node as the first frame, and copy the first frame, the copied first frame being used for generating the second live streaming frame; and
use continuously the first effect rendering nodes corresponding to subsequent first-effect-rendering-node information items in the first rendering queue to render the first frame, so as to obtain the first live streaming frame.

19. The non-transitory computer-readable storage medium of claim 16, wherein the computer-executable instructions causing the processor to render the first frame with the second effect rendering node of the second effect to obtain the second live streaming frame further cause the processor to:
delete, from the second rendering queue, a second-effect-rendering-node information item corresponding to the target effect rendering node, to obtain a target second rendering queue; and
render the first frame with a second effect rendering node indicated by a second-effect-rendering-node information item in the target second rendering queue, to obtain the second live streaming frame.

20. The non-transitory computer-readable storage medium of claim 17, wherein the first-effect-rendering-node information item comprises one or more of:
an identifier of a first effect rendering node, information of an effect resource corresponding to the first effect rendering node, or a rendering parameter corresponding to the first effect rendering node; and/or
wherein the second-effect-rendering-node information item comprises one or more of:
an identifier of a second effect rendering node, information of an effect resource corresponding to the second effect rendering node, or a rendering parameter corresponding to the second effect rendering node.
